(19) United States
(12) Patent Application Publication
(10) Pub. No.: US 2012/0320103 A1
(43) Pub. Date: Dec. 20, 2012

(54) Controlling Light Sources for Colour Sequential Image Displaying

(76) Inventors: Ronald D. Jesme, Plymouth, MN (US); William E. Phillips, III, Cincinnati, OH (US); Todd S. Rutherford, Wyoming, OH (US)

(21) Appl. No.: 13/519,229

(22) PCT Filed: Dec. 22, 2010
(86) PCT No.: PCT/US2010/061867

§ 371 Date: Jun. 26, 2012

Related U.S. Application Data
(60) Provisional application No. 61/292,314, filed on Jan. 5, 2010.

(51) Int. Cl. G09G 5/10

(52) U.S. Cl. 345/690

(57) ABSTRACT

Color sequential imaging involves illuminating, for each of two or more time-separated color fields, two or more light sources. Each of the two or more light sources emits at different wavelengths, and at least one of the first or second light sources is activated at different, non-zero current amplitudes during each of the first and second color fields. The color fields are projected via a spatial light modulator in synchronization with the activation of the at least one of the first or second light sources.

### TECHNICAL FIELD

This specification relates in general to electronic devices, and more particularly to systems, apparatuses, and methods for color sequential imaging.

### BACKGROUND

The term “pico projector” generally refers to a portable image and/or video device that can project onto a viewable surface such as a wall or screen. Producers of pico projectors are focusing on devices that are small, low-cost, bright, and consume little power. Such devices may have self-contained functionality (e.g., can play videos directly from computer readable media) and/or can complement other mobile devices (e.g., smartphones, laptop computers) as a peripheral device. As a result, pico projectors may offer valuable new capabilities and applications to the rapidly growing mobile device market.

Small, low-cost, bright, and low-power pico projectors may use color sequential projection to produce the video output. Color sequential projection refers to the forming of each frame of a full-color video image using sequentially projected fields (or planes), each field representing a different (e.g., primary) color. The fields are projected fast enough in sequence so that the human eye combines the fields to perceive a full-color image for each frame.

Early color sequential systems often used a color wheel to generate color sequential illumination. In such a system, the color sequence may be fixed by the physical properties of the color wheel. Such a wheel may have disadvantages when used in pico projectors (e.g., size, noise, power consumption, durability, brightness loss) and so pico projector systems are increasingly turning to colored light emitting diodes (LEDs) to generate the sequential color fields.

Using LEDs for pico projector illumination provides some advantages, including mechanical simplicity, reliability, relatively low power consumption, and relatively low cost. However, there is still room for improvement in the performance of LEDs in this type of application. For example, such devices may benefit from improvements in brightness and/or color gamut of the image, as well as from improvements related to energy efficiency of the projection device.

### SUMMARY

The present specification describes systems, apparatuses, computer programs, data structures, and methods for color sequential imaging. In one embodiment, an image display device includes first and second independently activated light sources that emit at different wavelengths from each other. A controller is coupled to the first and second light sources and is configured to activate the light sources during sequential first and second color fields. An imager is configured to receive light from said light sources and to display image content during each of the color fields. At least one of the first or second light sources is activated at programmably adjustable non-zero current amplitudes during each of the first and second color fields.

In another embodiment of the invention, a method involves illuminating, for each of two or more time-separated color fields, two or more light source. Each of the two or more light sources emits at different wavelengths, and at least one of the first or second light sources is activated at different, non-zero current amplitudes during each of the first and second color fields. The color fields are projected via a spatial light modulator in synchronization with the activation of the at least one of the first or second light sources.

In another embodiment of the invention, an apparatus includes at least three light emitting diodes (LEDs). Each of the LEDs emits light at different wavelengths from the other. The light is directed to a spatial light modulator that forms an image using sequential color fields. The apparatus include a driver that provides an adjustable, constant current source to each of the LEDs. The driver includes one or more enable inputs to selectably enable and disable each of the LEDs in synchronization with the color fields. At least one current controlling device is coupled to the driver. The current controlling device simultaneously provides, to the two or more of the LEDs via the driver, different, non-zero current amplitudes during two or more of the color fields.

The apparatuses and methods may further include programmably adjusting the non-zero current amplitudes in response to digital words inputted to one or more current controlling devices during both the first and second fields. In other configurations, the methods and apparatuses may selectively coupling two or more of the current controlling devices to the two or more light sources during the respective first and second color fields.

In other arrangements, apparatuses and methods may further include independently activating a third light source that emits at a wavelength different than both the first and second light source during a third color field. The third light source may be activated at respective programmably adjustable non-zero current amplitudes during two or more of the first, second, and third color fields. In such a case, the apparatuses and methods may further include independently activating a fourth independently activated light source during two or more of the first, second, and third color fields. In this case, the fourth light source may emit at a wavelength that is the same as one of the first three light sources, e.g., in a wavelength in a range of from 490 to 560 nm.

In other arrangements, the light sources may each comprise LEDs, and the LEDs may be commonly coupled at respective anodes of the light emitting diodes. In yet other configurations, both the first and second light sources may be activated at programmably adjustable non-zero current amplitudes during each of the first and second color fields to correspond to a plurality of selectable modes during operation of the image device. For example, one of the plurality of operating modes may increase brightness and power efficiency of the first and second light sources by using a reduced color gamut. In another example, one of the plurality of operating modes may increase brightness and power efficiency of the first and second light sources by using a grey scale color gamut. In such a case, at least one of the first or second light sources may be activated for a different time duration in the first color field than in the second color field.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### BRIEF DESCRIPTION OF THE DRAWINGS

The invention is described in connection with example embodiments illustrated in the following diagrams.

FIG. 1 is a block diagram of a system according to an example embodiment of the invention;

FIG. 2 is a is a block diagram illustrating sequential color imaging according to an example embodiment of the invention;

FIG. 3 is a chromaticity diagram illustrating relative color gamuts that may be produced in different modes of imaging systems according to example embodiments of the invention;

FIG. 4 is a block diagram illustrating a sequential imaging apparatus according to an example embodiment of the invention;

FIG. 5 is a timing diagram illustrating operation of the apparatus of FIG. 4 according to an example embodiment of the invention;

FIG. 6 is a block diagram illustrating an alternate sequential imaging apparatus according to an example embodiment of the invention;

FIG. 7 is a timing diagram illustrating operation of the apparatus of FIG. 6 according to an example embodiment of the invention;

FIGS. 8A, 8B, 9, 10, 12, 14, 16 and 18 are timing diagrams of color illumination for modes according to example embodiments of the invention;

FIGS. 11, 13, 15, 17, and 19 are chromacity diagrams of color gamuts related to the respective timing diagrams of FIGS. 10, 12, 14, 16 and 18;

FIG. 20 is a block diagram of an apparatus according to an example embodiment of the invention; and

FIG. 21 is a flowchart illustrating a method according to an example embodiment of the invention.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present invention is generally related to improved methods and apparatuses for producing images using sequential color imaging. Various embodiments are described herein in terms of light emitting diode (LED) projectors, although the invention need not be so limited. Embodiments of the present invention include an LED illumination control system that can provide software control of the LED illumination sequence of a color sequential imaging system. This approach reduces the physical volume and cost of the hardware, and can enable a single color sequential system to selectively obtain high values for color gamut, lumens, and/or lumens/watt.

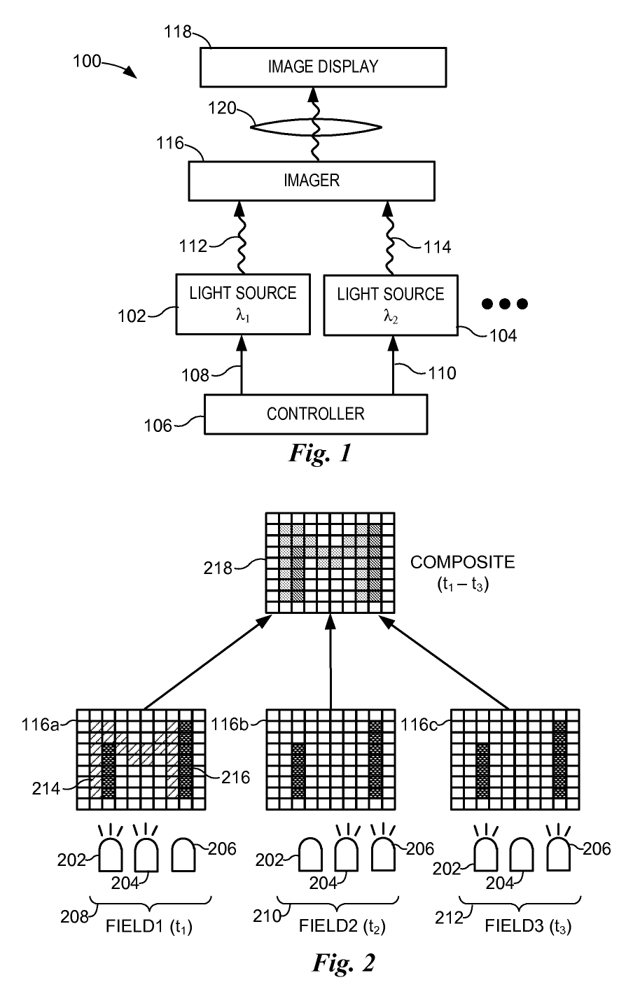

In reference now to FIG. 1, a block diagram illustrates a system 100 according to an example embodiment of the invention. The system 100 includes at least two independently activated light sources 102, 104 that emit at different wavelengths from each other. In the examples that follows, these light sources 102, 104 are described as LEDs, although the invention may be applicable to other light sources, including incandescent, fluorescent, and/or any other current or future electroluminescence technology. The system may include more than the two light sources 102, 104. Various embodiments described below may use three or four light sources, for example.

The light sources 102, 104 may each include multiple electroluminescent elements (e.g., semiconductor junctions of an LED), although these elements generally illuminate in unison for each individual source 102, 104 in the embodiment described herein. In some embodiments, the light sources 102, 104 may also each be self-contained physically, e.g., encased in common or separate component packages. For example, for a space-constrained device such as pico projector, each light source 102, 104 may include a single LED circuit board mount package. In other configurations, the lights sources 102, 104 may be housed in a single physical package with as multiple, independently-controllable LED junctions.

The light sources 102, 104 are controlled by way of a controller 106 that uses electrical signals 108, 110 to control the respective light sources 102, 104. The controller 106 is configured to at least activate the light sources 102, 104 during time-separated (e.g., sequential) first and second color fields that collectively form a color sequential image (e.g., video frame). The controller 106 may include driver circuits for powering the light sources 102, 104, or the drivers may be provided as physically-separate devices that receive inputs from the controller 106.

When activated, the light sources 102, 104 emit light 112, 114 which is received by an imager 116. The imager 116 may include features configured to receive light from the light sources 102, 104, and use the received light to selectively illuminate pixels on a display 118 during each of the color fields, e.g., by projecting the light via one or more lenses 120. For example, the imager 116 may cause only a selected subset of pixels to display for each color field. Such selective display of pixels by the imager 116 may be accomplished in a binary manner, e.g., either on or off for a particular pixel, or in a variable manner, e.g., causing each pixel to project the light 112, 114 in discrete or continuous range from off (no illumination) to on (fully illuminated). Example imager devices 116 include liquid crystal on silicon (LCoS) spatial light modulators and micro-mirror reflectors. Each pixel of these imaging devices 116 may be individually addressable so that digital logic can form multi-color images based on interactions between the imager 116, the controller 106, and the light sources 102, 104.

The image display 118 may vary depending on the particular technologies implemented in the imager 116 and light sources 102, 104. For example, where the imager 116 is configured for front projection, then the image display 118 may include any external surface suitable for projection, such as walls, screens, etc. Other display configurations, such as a rear-projection device, may have an integrated screen that is used as the image display 118.

Generally, sequential color imaging in the illustrated system 100 at least independently illuminates each of the light sources 102, 104 in synchronization with the spatial modulation of the imager 116. An example of this is shown in the block diagram of FIG. 2. In this example, three LEDs 202, 204, and 206 respectively emit three different colors (e.g., red, green, and blue) when illuminated. At least one of these LEDs 202, 204, and 206 are illuminated for respective color fields 208, 210, 212.

In this example, each color field 208, 210, 212 may be associated with the respective colors of the LEDs 202, 204, and 206 that illuminate during the time that the field is shown. Also during each color field 208, 210, 212, the imager 116 may cause individual pixels to be illuminated as needed for the respective color, as indicated by states 116a, 116b, and 116c in FIG. 2. In 116a, for example, shaded areas 214 and 216 may represent pixels that illuminate for the color field 208, with the different shading representing different intensities of illumination. In the time that passes during time t₁ (corresponding to color field 208) through time t₃ (corresponding to color field 212), the eye of an observer may perceive a composite image 218, e.g., on display 118.

In embodiments of the present invention, at least one of the light sources is activated at different non-zero current amplitudes during two or more of the color fields. This is seen in FIG. 2, where LEDs 202 and 204 are illuminated during field 208, LEDs 204 and 206 are illuminated during field 210, and LEDs 202 and 206 are illuminated during field 212. Various features related to the controller 106 (and other components) allow a display system to flexibly adapt display modes to enhance various aspects of the display, such as maximizing color range, brightness, power efficiency, etc. For example, the non-zero current amplitudes may be programmably adjustable to quickly change an operating mode of the system 100.

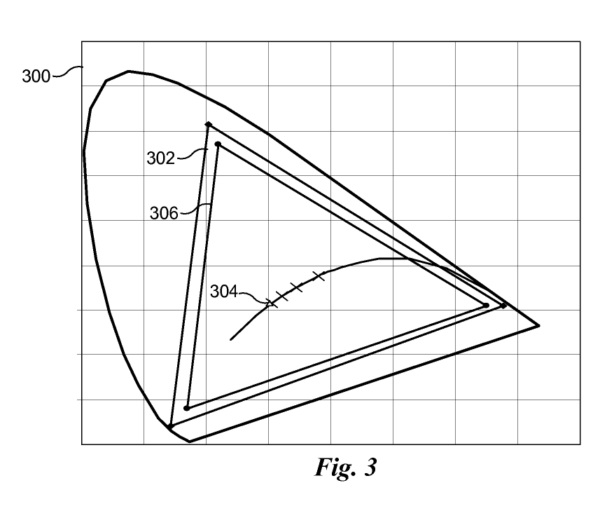

The formation of a range, or “gamut” of colors by combining a subset of primary colors is well known in the art. For example, a white pixel may be formed in such a system such as shown in FIG. 2 by illuminating all three LEDs at a particular level (corresponding to the “white point” in the color gamut) and so an imager 116 would cause a display element corresponding to the white pixel to be illuminated for each of the three color fields in states 116a-c. This is further shown in FIG. 3.

In FIG. 3, a chromaticity diagram 300 illustrates relative color gamuts within a CIE (Commission Internationale de l'Eclairage) color space that may be produced in different modes of imaging systems according to embodiments of the invention. By way of example and not of limitation, a system utilizing red, green, and blue LEDs is discussed. In one configuration (hereinafter referred to as “full color gamut”) only one of the red, green, and blue LEDs illuminates during each color field. The color gamut of such a system may have an outer boundary represented by triangle 302.

The particular boundary of the triangle 302 may be defined for any implementation based on a) the relative brightness of and b) the primary wavelengths of the red, green and blue LEDs. A white point 304 may be achieved by sequentially and independently illuminating each of the LEDs of each color field so that the composite color formed by the fields is white. A white point 304 may be defined by specifying a particular power level for each LED in each color field. In such a case, the white point 304 can be varied by varying the currents (and hence the optical powers) of the red, green and blue LEDs. However, this varying of individual currents does not necessarily change the color gamut 302 itself, because the color gamut 302 is a function of the colors of the red, green and blue LEDs as they are separately illuminated.

There may be situations where it is desirable to alter the gamut of a sequential color display. For example, it may be desirable to have a display gamut that matches the gamut for which a displayed image file was encoded. If an image file were encoded of a HDTV color gamut (as defined by ITU-R Recommendation BT.709, commonly known as Rec. 709), then the color reproduction will be most realistic if it is displayed on a system that has red, green and blue primaries as that defined by Rec. 709.

In other situations, it may be desirable to alter the gamut to trade off between a brighter image and the range of colors that may be accurately produced. One way to do this is to illuminate the colored LEDs, not only during their respective color fields, but also during other color fields. In this way, the LEDs that are not associated with a particular field can contribute to the overall optical output during that field, albeit with a tradeoff in reduced color range. Such a reduced color gamut may be seen as triangle 306 in FIG. 3.

A system capable of producing color gamut 302 may be configured to produce the color gamut 304 by programmably setting a non-zero current to cause at least one LED to illuminate outside of its color field as well as illuminating in its own color field. Although this may reduce the range of colors that can be accurately represented, it provides the potential to increase the brightness of the image by providing more illumination. In such a system, the colored LEDs are illuminated not only during their respective color field, but also at reduced amplitudes during other color fields, providing an increase in overall image brightness.

When a reduced color gamut image is viewed in an environment with significant ambient lighting, the image may be perceived as having more contrast than a full color gamut, because the increased brightness can provide a greater contrast ratio relative to the black level that can be defined predominantly by the ambient lighting. While it may be desirable to provide flexibility to the LED illumination scheme, it may also may be desirable do so without increasing the amount or complexity of hardware.

An increase in required hardware may lead to increases in cost, size, power consumption, complexity, etc., of the end product, and all of these parameters may need to be optimized at the same time for a particular mobile device. For example, the cost of particular hardware may be dominated by the number of integrated circuits required to implement the design. In the case of some components like LED drivers, the ultimate size of the apparatus may be dominated by the number of inductors required for the LED driver channels. These and other design considerations are taken into account in the design of the compact, low-cost, and flexible LED drive arrangements that are described herein.

For example, it may desirable for a portable projecting device to have a standard high color gamut mode (each LED on only during its respective color time slot). It may also be desirable to have a white only gamut (little or no color, all three LEDs on for each color time slot) to have a high brightness mode, useful for black & white text and line drawing display. Other display modes that may be useful for such a device include a) a green color mode (green LED on for all three color slots) to enable the highest lumens per watt specification; b) selectable color “leaking” to enable brightness vs. gamut trade-off selection; c) a red mode (red LED on for all three color slots) that could help maintain night vision (for military and or astronomy applications); and d) a selectable gamut. It may be desirable to have these and other modes automatically applied and adjusted via software, e.g., by detecting displayed content and/or environment, and automatically selecting and/or adjusting modes to best suit the situation. It may also be desirable (and/or sufficient) to offer these modes as manually selectable, adjustable, and activated via user inputs.

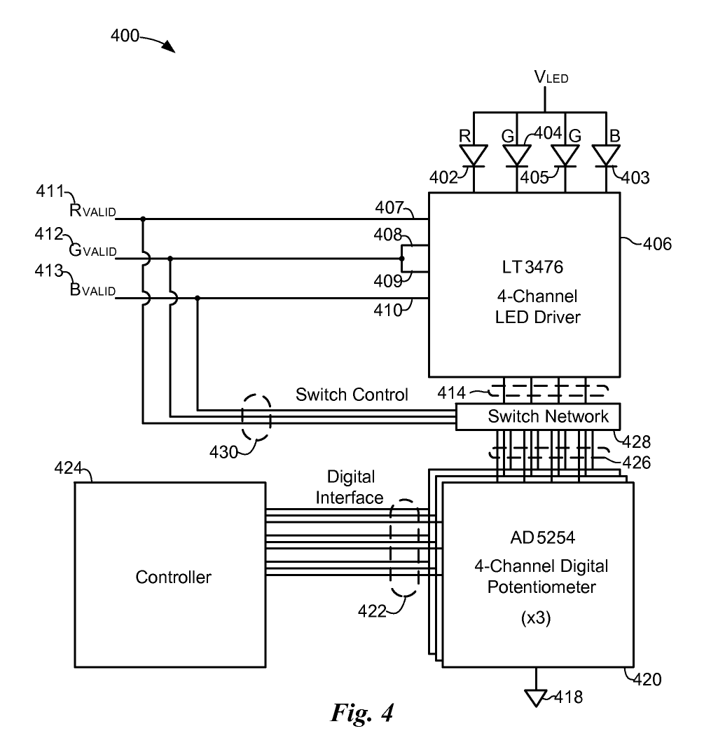

In reference now to FIG. 4, a block diagram illustrates at least part of a sequential imaging apparatus 400 according to an example embodiment of the invention. The apparatus includes LED light sources 402-405. The LEDs 402 and 403 are respectively red and blue, while both LEDs 404 and 405 are green (e.g., emit in wavelength in the range of 490 to 560 nm). The green LEDs 404, 405 may be configured to illuminate simultaneously with each other, and as a result may be considered as a single light source in the embodiments described herein. The use of two green LEDs 404, 405 not a conceptual necessity, but may be useful in some systems to achieve the desired amount of green optical power.

The current sent to the LEDs is controlled by way of a driver circuit 406. In this example, the driver 406 is a four-channel, high efficiency LED driver such as the LT3476 made by Linear Technology Incorporated. The driver 406 includes activation inputs 407-410 used to independently enable or disable each of the LEDs 402-405. This activation occurs in response to red, green, and blue activation signals 411-413. As described above, the green LEDs 404-405 may be configured to act as a single light unit, which is indicated here by the coupling together both inputs 408 and 409 to the green activation signal 412.

Activation of the LEDs 402-405 may be facilitated by a controller 424. The controller 424 may include logic circuitry that facilitates illumination of the LEDs 402-405 in synchronization with an imager such as a spatial light modulator (SLM) (e.g., imager 116 in FIG. 1). Generally, the imager selectively allows, light from the LEDs 402-405 to pass through individual addressable elements for each color field, thereby projecting the pixels that are to be illuminated for the color field. The controller 424 and/or imager 116 may provide the activation signals 411-413 in synchronization with the state of the imager 116 for each color field.

Generally, the LEDs 402-405 are illuminated only when the imager 116 is in a state suitable for projecting the color field, and are switched off when the imager 116 is switching between color fields. This is because the state of imager 116 can be unreliable during the switching time, and thus illuminating the imager during the switching time may introduce image artifacts. To reduce the chance for such artifacts, the system may pulse the current to the LEDs 402-405 for each color field via the activation signals 411-413 when the imager 116 has finished transitioning between fields, either via the controller 424 or via the imager itself.

In one embodiment of the invention, when the LEDs 402-405 are illuminated, they are illuminated for the entire duration of a color field. This may help prevent image artifacts that might be introduced if the imager used pulse width modulation to achieve “gray scale” within a color field. In such a case, the imager itself may include features for providing grey scale within a color field, such as varying reflectivity or transmissibility of each pixel element within the imager.

In either case, the activation signals 411-413 are used to activate or deactivate the LEDs 402-405, and are not intended to control the amount of current provided by the LEDs 402-405, which in turn affects the maximum illumination of the LEDs 402-405 during the color fields. Instead, inputs 414 to the driver 406 are used control the currents applied to LEDs 402-405 when they are activated. The inputs 414 may control the currents, for example, by setting a voltage between the inputs 414 and ground 418 (such as in the case of the LT346 driver 406). This is accomplished in the illustrated example by way of one or more digital potentiometers 428, a switching circuit 422, and the controller 424.

The apparatus 400 uses three different color LEDs 402-405 for three color fields, and all of the LEDs may be illuminated using different current values during each color field. As a result, nine different current values may need to be set via the potentiometers 420 for any given display mode: three current values for each LED during each of three color fields. This is seen by the nine signals 422 send as inputs to the potentiometers 420. Each of the signals 422 may be a multi-bit word, such as an 8-bit word used to set one of 256 voltage levels for a given channel. In this example the potentiometers 420 are Analog Devices AD5252, which is a quad-channel, nonvolatile memory, digitally controlled potentiometer with 256 positions. These digital potentiometers 420 may perform similar electronic adjustment functions as performed by mechanical potentiometers, trimmers, and variable resistors, but do so in an easily programmable way.

In response to the nine input words 422, the potentiometers 420 may provide variable voltage to twelve current control lines 426. In this embodiment, each of the green LEDs 404, 405 may be assigned a dedicated one of the twelve current control lines 426. In such a case, one of the input words 422 may be fed in parallel (not shown) to two inputs in each of the potentiometers 420. In other arrangements, only three channels of each of the potentiometers 420 may be used, and the two of the current control lines 426 (e.g., those associated with the green LEDs 404, 405) may be tied together in parallel, resulting in only nine independent current control lines 426 leaving the potentiometers 420.

Because the time needed to set the potentiometers 420 may be longer than the time between successive color fields, each one of the three potentiometers 420 may be coupled to the driver 406 via a switching network 428. The switching network 428 selectively couples the potentiometers 420 to the driver inputs 414 for each color field in response to the field activation signals 411-413. In this way, the LED currents of the LEDs 402-405 can be quickly changed for each color field regardless of the switching speed of the potentiometers 420.

The switching network 428 may be transitioned from a first to second voltage in less time than is required for the imager 116 (e.g., SLM) to transition to the next color field image. This switching action can reduce the number of LED driver circuits 406 required compared to a system that uses, for example a separate multi-channel driver 406 for each color field. In the illustrated arrangement, each of the LED driver channels of the one driver 406 can be utilized during each of the color fields, eliminating redundant circuitry that would be idle much of the time. The switching of the switch network 428 can be synchronized with the imager 116, as shown here by the control lines 430 being split off from the activation signals 411-413. Alternately, the activation signals 411-413 could be routed to the controller 424, which in turn could control the switch network 428 to operate in sequence with the imager 116.

It will be appreciated that the relative currents of the LEDs 402-405 may be programmably altered for setting different display modes, such as maximum color gamut mode, increased brightness mode, etc. In those cases, the time required to set or update the potentiometers 420 may not be an issue, because mode changes may only occur infrequently. Further the user may expect to see some temporary artifacts or the like when switching modes, so such artifacts may not be objectionable in that situation. In other arrangements, the LEDs 402-405 can be turned off while the potentiometers 420 are set or adjusted.

One advantage of this scheme is that the driver 406 illuminates each of LEDs 402-405 as a dominant light source during the associated color fields, and also illuminates them as a gamut-reducing light sources during other color fields. Such a system only needs three or four LEDs 402-405 as light sources, which reduces the space required to house the LEDs 402-405.

Each channel of a high-efficiency LED driver such as driver 406 may utilize an inductor (not shown) to minimize the ripple current in each LED 402-405. These inductors are sometimes the largest components of the LED drive circuit. Thus, by using only one driver 406 for the four channels, only one inductor is needed for each LED 402-405. This may reduce the space needed to house the driver 406 and its associated circuitry compared, for example, to a system that uses multiple drivers 406.

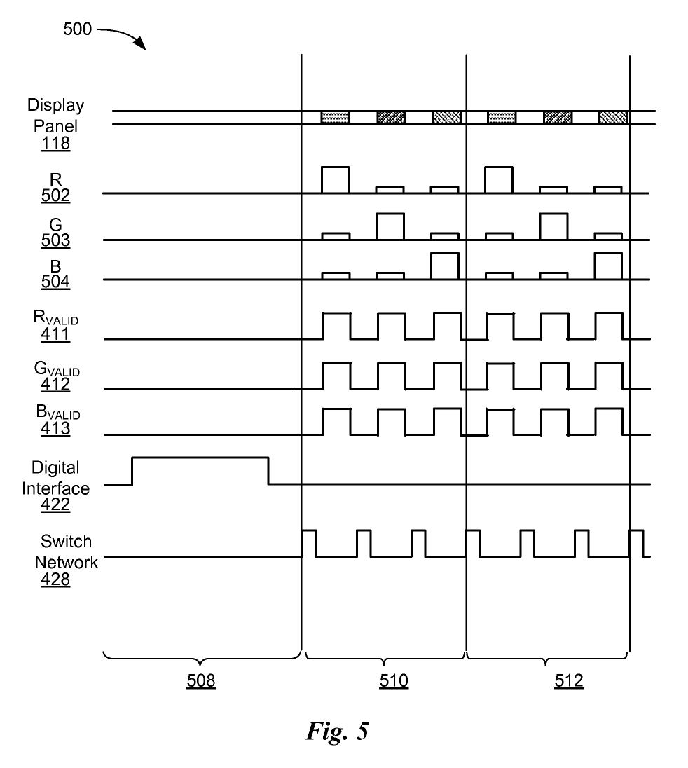

To facilitate a better understanding of the apparatus shown in FIG. 4, a timing diagram 500 according to an embodiment of the invention is shown in FIG. 5. The signal associated with the switch network 428 is shown as pulses that cause selected potentiometers 420 to be coupled to the driver 406. The digital interface signal 422 indicates general activity on the digital lines used to set/adjust some or all of the channels of the digital potentiometers 420.

The timing diagram 500 further shows the state of activation signals 411-413, which transition from low to high to turn on the respective colored LED 402-405. In this example, the controller 424 and/or imager 116 may be configured to set all the signals 411-413 the same for each color field. As will be shown further below, an OR gate may be instead be used to combine the signals 411-413 should the signals 411-413 only be individually activated from the controller and/or imager 116 for each field.

The signals 502-504 represent respective illumination values of the respective red, green, and blue LEDs 402-405. These values may be approximately proportional to the amount of current applied to the LEDs 402-405. The display panel 118 signal indicates a composite of the three illumination values 502-504 that may be seen at the imager 116 and/or display panel 118.

The timing diagram 500 includes an initialization period 508 and two successive video frames 510 and 512 such as may be associated with the apparatus 400 of FIG. 4. During the initialization period 508, the potentiometers 420 are loaded with the current magnitude values that will be used during subsequent device operation. Also during this period 508, the LEDs 402-405 remain off, as indicated by constant low state of the activation signals 411-413, and by no illumination of signals 502-504 or display panel 118.

During the illustrated video frames 510, 512, as well as subsequent frames, the digital interface 422 is inactive. This is because the potentiometers 420 will hold their previous settings, and the relative current amplitude of the LEDs 402-405 will remain constant during the current mode of operation. For each of the frames 510, 512, the activation signals 411-413 are shown pulsing three times, one for each of the red, green, and blue color fields. As can be seen by the relative amplitude of light source illumination 502-504, the device is currently operating in a reduced color gamut, such as gamut 306 seen in FIG. 3. So, during the red color fields, for example, the red illumination 502 is at a high level, while the green and blue illuminations 503, 504 are lower but not zero. This off-field illumination of the green and blue 503-504 helps increase brightness of the output seen at the display panel 118 during the red field.

To achieve a reasonable white point, the optical power of the red, green and blue colors 502-504 may be approximately equal, as depicted in the diagram by equal amplitudes and durations of the red, green and blue illumination pulses 502-504. To adjust the white point, the amplitude and/or duration of the color pulses may be adjusted. However, the timing (both duration and temporal location) of these illumination pulses 502-504 may still be synchronized with the imager 116, as the illumination is driven by activation signals 411-413 which may originate via the imager 116.

Color sequential projection systems may transform the input image data from each video frame into red, green and blue color fields. Each color field is sequentially represented on the imager 116 while the imager 116 is illuminated with the respective color. The white point can be set by adjusting the relative optical powers of the red, green and blue illumination pulses. For example, if the white point was too greenish, the amplitude of the green illumination pulse train 503 could be reduced while retaining the amplitude of the red and blue illumination pulse trains 502, 504. This could be achieved by adjusting channels of the digital potentiometers 420 associated with the green LEDs 404, 405.

Note that the implementation shown in FIG. 4 may also provide other advantages besides facilitating easy selection and adjustment of video modes. For example, it can be seen that the anodes of all LEDs 402-405 are electrically interconnected. This allows readily connecting the LEDs 402-405 to a common thermal management structure (such as an electrically conductive metal heat sink). In such an arrangement, each anode is at the same electrical potential, eliminating the need for each LED 402-405 to be fully electrically insulated from one another. This is an advantage because the introduction of an electrical insulator typically introduces an unwanted thermal resistance, hampering the cooling of the LEDs. Heat can impair the LED performance and shorten the life of the LED.

Another advantage of the illustrated apparatus 400 is the utilization of the LT3476 driver which uses a DC/DC converter to efficiently convert the power supply voltage to a controlled current value for each LED s 402-405. It is beneficial to incorporate an inductor into each current controlled path to minimize current ripple, because high current ripple (such as with a pulse width modulation solution) can result in reduced LED performance (e.g., reduced lumens output per electrical power input). Note that the functions of the controller 424 function can be distributed among various elements, such as the imager/SLM. Also note that the independently controlled current paths can provide independent and simultaneous control of each LED current, providing flexibility in current pulse magnitude and timing on a per LED basis.

It should be noted that the apparatus 400 may also be configured to operate using a pulse width modulation (PWM) system to control the average LED current, which in turn may also control the perceived LED lumens. In such a case, additional provisions may be needed to ensure that this time domain signal would not cause image artifacts in conjunction with a SLM that uses PWM to modulate the brightness of individual pixels. One approach is to PWM the LED at a rate much higher rate than used by the SLM. For example, the LT3476 has been successfully PWM'ed at 1.5 MHz without noticeable image artifacts. Another approach is to avoid PWM as a means of controlling LED current to thus avoid the creation of image artifacts, but rather control the amplitude of each LED current pulse as shown, e.g., in FIG. 5.

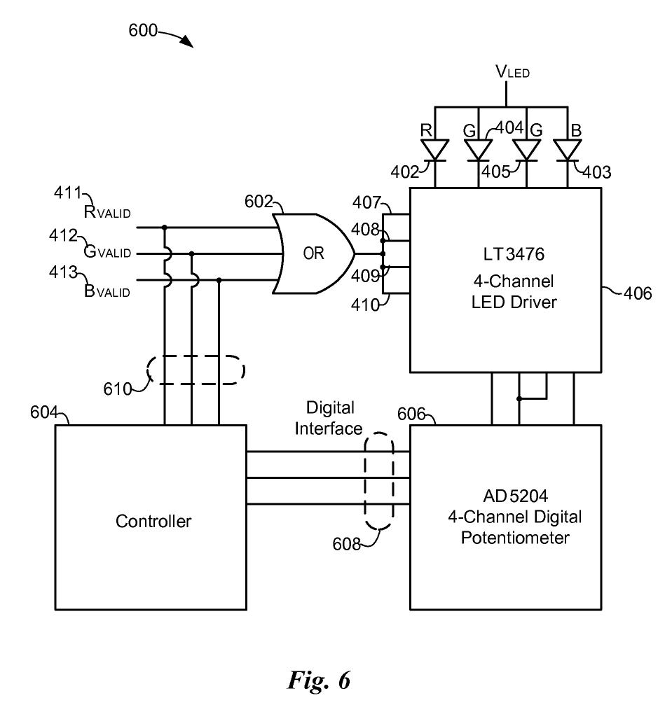

In reference now to FIG. 6, a block diagram illustrates an alternate circuit arrangement for an apparatus 600 according to an embodiment of the invention. This arrangement 600 uses an LT3476 driver 406 coupled to LEDs 402-405 similar to the apparatus of FIG. 4. Unlike FIG. 4, the activation signals 411-413 are not directly coupled to the inputs 407-410 of the driver 406, but are logically combined via an OR gate 602. The logical OR function of gate 602 can be implemented in discrete logic or with other means such as a controller or other digital hardware.

The illustrated arrangement 600 also includes a controller 604 that may provide similar functions as controller 424 in FIG. 4. In this arrangement 600, however, the activation inputs 411-413 are also sent to the controller 604 via control lines 610. The controller 604 uses these lines 610 to control a single, four-channel potentiometer 606 via digital interface 608. This arrangement 600 replaces the three digital potentiometers 420 shown in FIG. 4 with a single, higher speed digital potentiometer 606, represented here by model number AD5204 from Analog Devices.

The digital potentiometer 606 can be chosen based on its capability to be transitioned from a first to second voltage in less time than is required for the imager 116 to transition to from one color field to the next. This may be possible depending on the relative switching times of the imager 116 and the potentiometer 606.

As was previously mentioned, the control lines 610 (e.g., originating from the imager 116) are routed to the controller 604 so that the controller 604 can update the digital potentiometer 606 in sequence with the imager 116. This allows the circuit 600 to potentially reduce the cost and volume of the system over that of the previously described apparatus 400, while still providing full LED drive sequence flexibility.

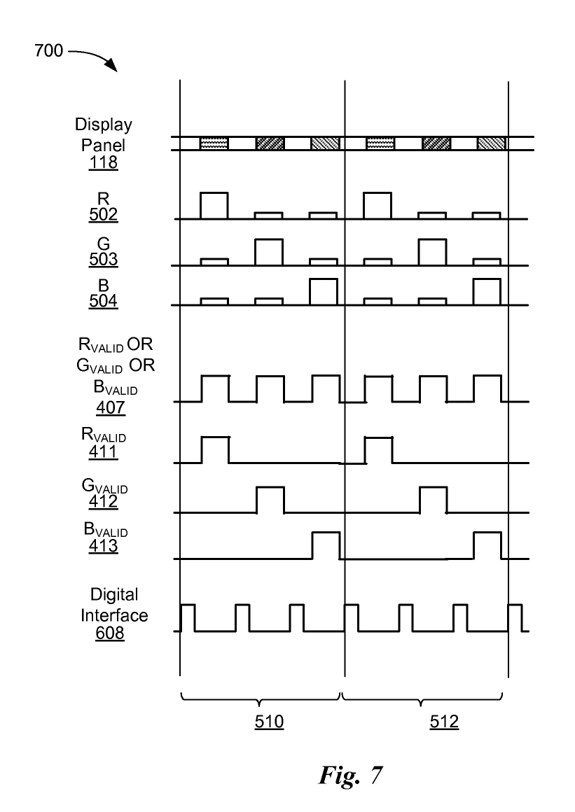

In reference now to FIG. 7, a timing diagram 700 illustrates how the circuit of FIG. 6 may produce a reduced color gamut for two video frames 510, 512, using like reference numbers to denote components of diagram 500 in FIG. 5. In this diagram 700, the activation signals 411-413 are only pulsed during the respective red, green, and blue color fields, and an additional signal seen at input 407 (and inputs 408-410) to the driver 406. This signal at 407 is formed from the logical OR of signals 411-413. Also, the digital interface 608 receives configuration words for each color field, thereby setting magnitude values for each of the three colors. This is seen at interface 608 as three pulses during each frame 510, 512 that each change the current to the LEDs 402-405 and thereby provide the varying illumination values 502-504 seen each during color field.

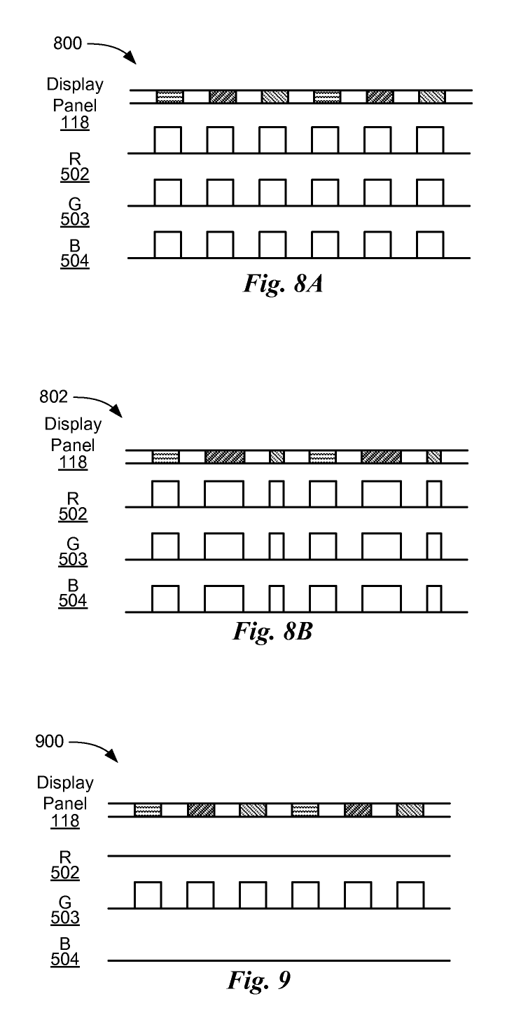

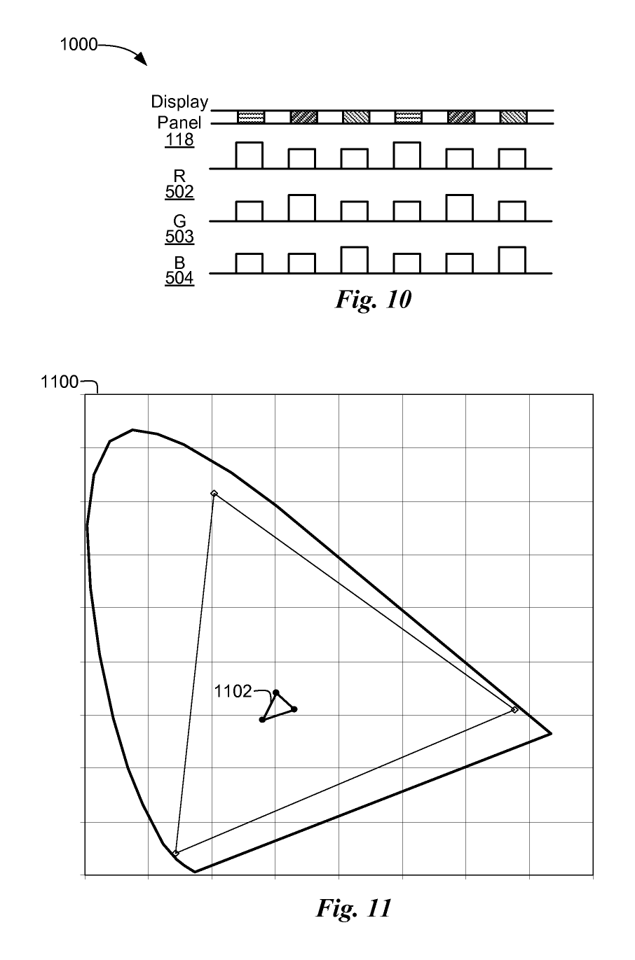

One advantage of the various embodiments shown above is that they allow a device to readily switch display modes to suit local conditions. Such conditions include, but are not limited to, type of source material displayed, ambient light, source of power, battery levels, projection surface, etc. In FIGS. 8A, 8B, and 9-19, various modes and their characteristics according to example embodiments are shown and described. In FIGS. 8A, 8B, 9, 10, 12, 14, 16 and 18, color illumination timing diagrams illustrate other possible modes according to additional embodiments of the invention, similar to the color illumination signals 502-504 shown in FIGS. 5 and 7. In addition, FIGS. 11, 13, 15, 17, and 19 show chromacity diagrams of the gamuts represented by respective timing diagrams of FIGS. 10, 12, 14, 16 and 18. This is not intended to be an exhaustive list of all possible modes that can be provided by embodiments of the invention, but is intended to illustrate examples of different modes and their possible uses.

In diagram 800 of FIG. 8A, all of the colors illuminate 502-504 at or near maximum for all fields. Therefore this diagram 800 represents a grey scale mode. This mode may provide the brightest possible display because all LEDs are on at high brightness during all color fields. A grey scale presentation can be an acceptable means of viewing information such as text, line drawings, flowcharts, etc.

Similarly, timing diagram 802 in FIG. 8B will also produce a grey scale. However, the duration of the color fields in diagram 802 are not equal, resulting in grey scale color differentiation for equally saturated primary colors, with green being the brightest and blue the least bright. This translates fully saturated primary colors to different shades of grey enabling them to be distinguished even in a grey scale presentation. The ability to distinguish color may be useful in the interpretation of images such as plots and charts where color is used to convey information. This feature can enable the viewer to distinguish features that may not otherwise be distinguished in a grey scale representation. This feature may create an unnatural grayscale representation of some image content because of the color to gray scale transform characteristic.

The timing diagram 900 in FIG. 9 may produce the highest efficiency (e.g., lumens per watt) because only the most efficient (in terms of lumens per watt) color is used, namely green. Unequal durations for each of the color fields could be used help differentiate saturated image colors as described in the grey scale scenario. Similarly, it may also be useful to produce a color gamut that is substantially red, or any other color. This could have artistic value, etc. A substantially red color gamut could alternately be used to preserve night vision, for example.

The approach seen in the timing diagram 1000 in FIG. 10 is similar to the previous approaches shown in FIGS. 8A and 8B, but further provides a hint of color. This is indicated by color gamut 1102 in the chromacity diagram 1100 of FIG. 11. This hint of color can enable a viewer to distinguish colors, while still providing high brightness. The ability to distinguish color may be useful in the interpretation of images such as plots and charts, e.g., where color is used to convey information.

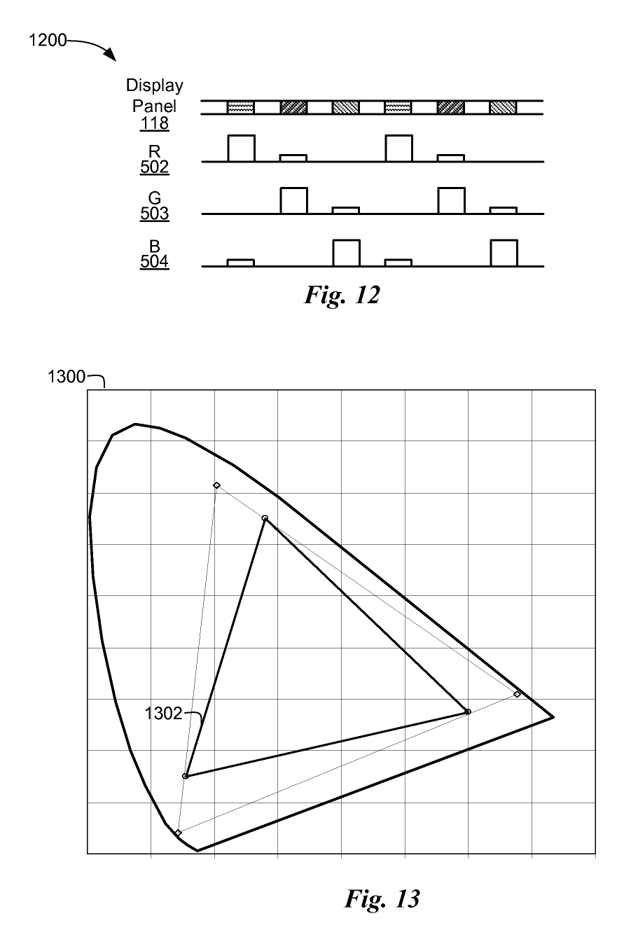

In reference now to FIGS. 12 and 13, a timing diagram 1200 illustrates a color mode that introduces a slight rotation of a reduced color gamut, as shown by the triangle 1302 in chromacity diagram 1300 of FIG. 13. As can be seen in the timing diagram 1200, this is accomplished by illuminating a primary color LED at or near full power during its color frame, and illuminating one other non-associated LED during that frame at a low power, while the third LED remains off for that frame. This may provide a balance between brightness and power consumption, as only two LEDs are illuminated per color field.

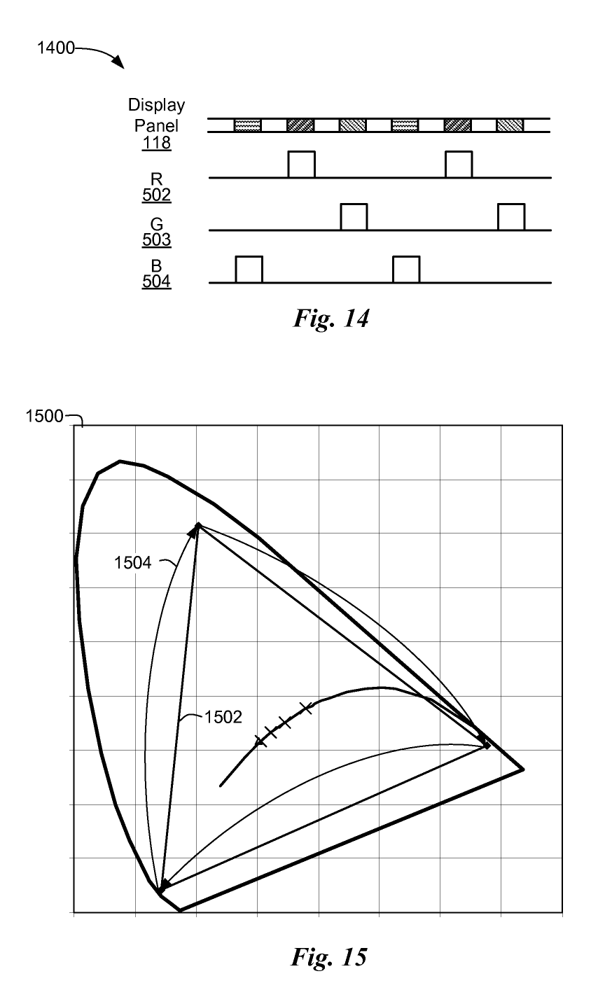

In reference now to FIGS. 14 and 15, a timing diagram 1400 illustrates a color mode that introduces a full rotation of a full-color gamut, as shown by the triangle 1502 in chromacity diagram 1500 of FIG. 15. As can be seen in the timing diagram 1400, this is accomplished by substituting a primary color LED at or near full power during a color field associated with a different color. The resulting color gamut 1502 may encompass a similar range, but is rotated, as indicated by arrows, e.g., 1504. This may have uses such as for troubleshooting, or artistic/special effects.

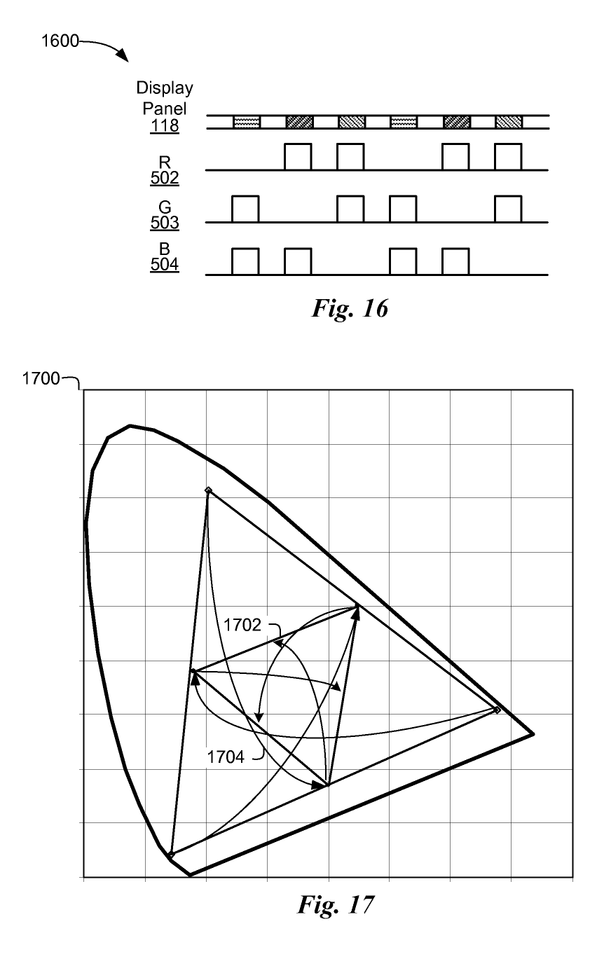

In reference now to FIGS. 16 and 17, a timing diagram 1600 illustrates a color mode that introduces a reverse-color gamut, as shown by the triangle 1702 in chromacity diagram 1700. As can be seen in the timing diagram 1600, this is accomplished by substituting the two primary color LEDs at or near full power during a color field associated with the third color, which is not illuminated during its own color field. The resulting color gamut 1702 may encompass a reduced range, as well as being rotated, as indicated by arrows, e.g., 1704. This may have uses such as for troubleshooting or artistic/special effects.

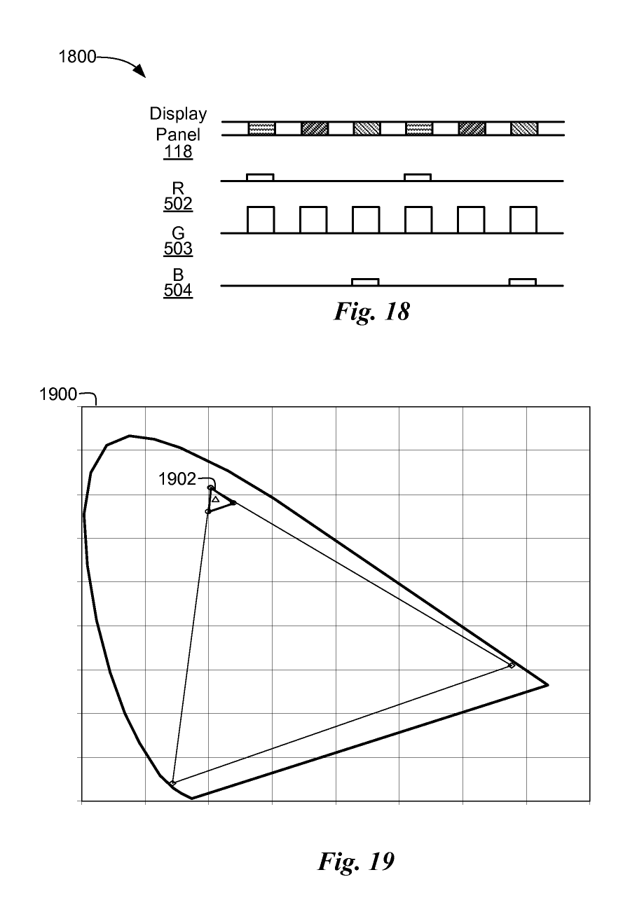

In reference now to FIGS. 18 and 19, a timing diagram 1800 illustrates a color mode that introduces a green scale with a hint of color, as shown by the triangle 1902 in chromacity diagram 1900. This approach is similar to approach illustrated in FIG. 9, but provides a hint of color. This hint of color can enable a viewer to distinguish colors, while still providing very high efficiency by using mostly green illumination. The ability to distinguish color may be useful in the interpretation of images such as plots and charts where color is used to convey information.

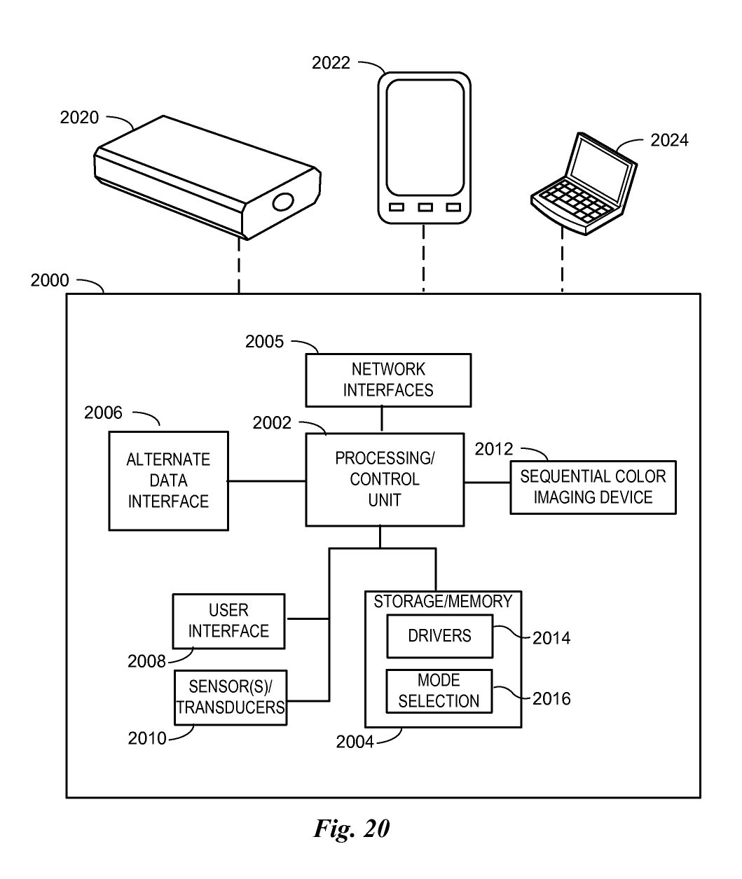

Many types of apparatuses may utilize sequential color imaging as described herein. Users are increasingly using mobile devices on a regular basis. In reference now to FIG. 20, an example embodiment is illustrated of a representative mobile apparatus 2000 capable of carrying out operations in accordance with example embodiments of the invention. Those skilled in the art will appreciate that the example apparatus 2000 is merely representative of general functions that may be associated with such devices, and also that fixed computing systems similarly include computing circuitry to perform such operations.

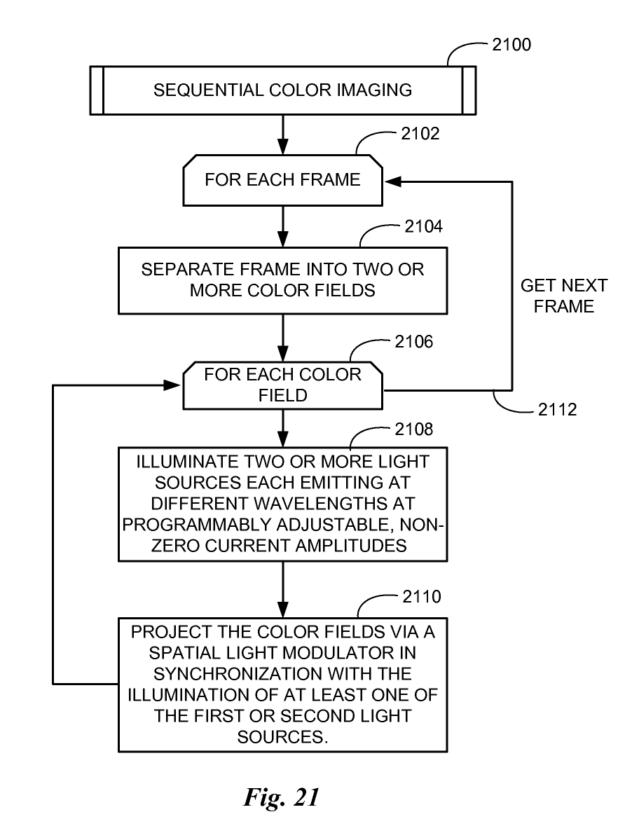

The apparatus 2000 may include, for example, a projector 2020 (e.g., portable universal serial bus projector, self-contained pico projector), mobile phone 2022, mobile communication device, mobile computer, laptop computer 2024, desk top computer, phone device, video phone, conference phone, television apparatus, digital video recorder (DVR), set-top box (STB), radio apparatus, audio/video player, game device, positioning device, digital camera/camcorder, and/or the like, or any combination thereof. The apparatus 2000 may include features of the arrangements 100, 400 and/or 600 shown and described in FIGS. 1, 4, and 6 and be capable of displaying modes shown described in FIGS. 5 and 7-19. Further, apparatus 2000 may be capable of performing functions such as described below relative to FIG. 21.

The processing unit 2002 controls the basic functions of the apparatus 2000. Those functions associated may be included as instructions stored in a program storage/memory 2004. In an example embodiment of the invention, the program modules associated with the storage/memory 2004 are stored in non-volatile electrically-erasable, programmable read-only memory (EEPROM), flash read-only memory (ROM), hard-drive, etc. so that the information is not lost upon power down of the mobile apparatus. The relevant software for carrying out operations in accordance with the present invention may also be provided via computer program product, computer-readable medium, and/or be transmitted to the mobile apparatus 2000 via data signals (e.g., downloaded electronically via one or more networks, such as the Internet and intermediate wireless networks).

The mobile apparatus 2000 may include hardware and software components coupled to the processing/control unit 2002. The mobile apparatus 2000 may include one or more network interfaces 2005 for maintaining any combination of wired or wireless data connections via any combination of mobile service provider networks, local networks, and public networks such as the Internet and the Public Switched Telephone Network (PSTN).

The mobile apparatus 2000 may also include an alternate network/data interface 2006 coupled to the processing/control unit 2002. The alternate data interface 2006 may include the ability to communicate via secondary data paths using any manner of data transmission medium, including wired and wireless mediums. Examples of alternate data interfaces 2006 include USB, Bluetooth, RFID, Ethernet, 802.11 Wi-Fi, IRDA, Ultra Wide Band, WiBree, GPS, etc. These alternate interfaces 2006 may also be capable of communicating via cables, networks, and/or peer-to-peer communications links.

The processor 2002 is also coupled to user-interface hardware 2008 associated with the mobile apparatus 2000. The user-interface 2008 of the mobile terminal may include a display 2020, such as a liquid crystal display (LCD) device. The user-interface hardware 2008 also may include a transducer, such as an input device capable of receiving user inputs. A variety of user-interface hardware/software may be included in the interface 2008, such as keypads, speakers, microphones, voice commands, switches, touch pad/screen, pointing devices, trackball, joystick, vibration generators, lights, accelerometers, etc. These and other user-interface components are coupled to the processor 2002 as is known in the art.

The apparatus 2000 may include sensors/transducers 2010 that are part of or independent of the user interface hardware 2008. Such sensors 2010 may be capable of measuring local conditions (e.g., ambient light, location, temperature, acceleration, orientation, proximity, etc.) without necessarily requiring interacting with a user. Such sensors/transducers 2010 may also be capable of producing media (e.g., text, still pictures, video, sound, etc).

The apparatus 2000 further includes at least one sequential color imaging device 2012 having features as described herein. The imaging device 2012 may utilize hardware, firmware, software, drivers, etc., to project still and/or video images. Such projection may cause images to be viewable on an external display surface and/or a display surface integral to the apparatus 2000. The device 2012 may be the primary functional component of the apparatus 2000, such as where the apparatus 2000 is configured as a pico projector peripheral device. In other arrangements, the imaging device 2012 may be a supplemental device, e.g., supplementary to a primary display device of the user interface 2008.

The program storage/memory 2004 includes operating systems for carrying out functions and applications associated with functions on the mobile apparatus 2000. The program storage 2004 may include one or more of read-only memory (ROM), flash ROM, programmable and/or erasable ROM, random access memory (RAM), subscriber interface module (SIM), wireless interface module (WIM), smart card, hard drive, computer program product, and removable memory device.

The storage/memory 2004 may also include one or more software drivers 2014 for driving the imaging device 2012. The software driver 2014 may include any combination of operating system drivers, middleware, hardware abstraction layers, protocol stacks, and other software that facilitates accessing and interface with the imaging device 2012 and associated hardware.

The storage/memory 2004 of the mobile apparatus 2000 may also include specialized software modules for performing functions according to example embodiments of the present invention. For example, the program storage/memory 2004 may include a mode selection module 2016 that enables manual or automatic changing of modes related to the imaging device 2012. For example, a user may enable, via the module 2016, an automatic mode selection that enters a reduced gamut/increased brightness mode based on ambient light detected via sensors 2010. In other arrangements, the user may manually select, via the module 2016, a grayscale mode for near maximum brightness based on particular content to be displayed (e.g., a presentation with black and white text/drawings).

The mobile apparatus 2000 of FIG. 20 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure utilizing a display.

In reference now to FIG. 21, a flowchart illustrates a procedure 2100 for sequential imaging display according to an example embodiment of the invention. The procedure involves iterating (e.g., in an infinite loop) 2102 through separate video frames. Each frame is separated 2104 into two or more color fields, and a loop 2106 is entered for each color field. For each color field, two or more light sources each emitting at different wavelengths are illuminated 2108 at programmably adjustable, non-zero current amplitudes. The color fields are projected 2110 via a spatial light modulator in synchronization with the illumination of at least one of the first or second light sources. Upon processing of all of the color fields, the loop exits 2112 and the next frame is processed at via loop 2102.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. An image display device comprising:
first and second independently activated light sources that emit at different wavelengths from each other;
a controller coupled to the first and second light sources, wherein the controller is configured to activate the light sources during time-separated first and second color fields; and
an imager configured to receive light from said light sources and to display image content during each of the color fields, wherein at least one of the first or second light sources is activated at different non-zero current amplitudes during each of the first and second color fields.

2. The image display device of claim 1, further comprising:
a current controlling device coupled to the two or more light sources for programmably adjusting the non-zero current amplitudes in response to digital words inputted to the current controlling device during both the first and second fields.

3. The image display device of claim 1, further comprising:
first and second current controlling devices respectively associated with the first and second color fields that each facilitate programmably adjusting the non-zero current amplitudes in response to digital words respectively inputted to the first and second current controlling devices; and
a switching device that couples the first and second current controlling devices to the two or more light sources during the respective first and second color fields.

4. The image display device of claim 1 further comprising:
a third independently activated light source that emits at a wavelength different than both the first and second light source; and
wherein the controller is further coupled to the third light source and configured to activate the third light source during a third color field, and wherein the third light source is activated at respective different non-zero current amplitudes during two or more of the first, second, and third color fields.

5. The image display device of claim 4, further comprising:
a fourth independently activated light source; and
wherein the controller is further coupled to the fourth light source and configured to activate the fourth light source during two or more of the first, second, and third color fields.

6. The image display device of claim 5, wherein the fourth light source emits at a wavelength that is the same as one of the first three light sources, and the fourth light source emits light of a wavelength in a range of from 490 to 560 nm.

7. (canceled)

8. The image display device of claim 1, wherein the light sources each comprise light emitting diodes, and the light emitting diodes are commonly coupled at respective anodes of the light emitting diodes.

9. (canceled)

10. The image device of claim 1, wherein both the first and second light sources are activated at programmably adjustable non-zero current amplitudes during each of the first and second color fields to correspond to a plurality of selectable operating modes during operation of the image device.

11. The image device of claim 10, wherein one of the plurality of operating modes increases brightness and power efficiency of the first and second light sources by utilizing a reduced color gamut, or a grey scale color gamut.

12-14. (canceled)

15. A method comprising:
illuminating, for each of two or more time-separated color fields, two or more light sources, wherein each of the two or more light sources emits at different wavelengths, and wherein at least one of the first or second light sources is activated at different, non-zero current amplitudes during each of the first and second color fields; and
projecting the color fields via a spatial light modulator in synchronization with the activation of the at least one of the first or second light sources.

16. The method of claim 15, wherein the non-zero amplitudes are programmably adjustable via inputting digital words to first and second current controlling devices associated with the respective first and second color fields, the method further comprising switching a coupling between the first and second current controlling devices and the two or more light sources during the respective first and second color fields.

17. The method of claim 15, wherein the non-zero amplitudes are programmably adjustable via inputting, for each of the first and second color fields, digital words to a single current controlling device that is coupled to the two or more light sources.

18. The method of claim 15, further comprising selecting one of a plurality of operating modes during operation of the image device, wherein both the first and second light sources are activated at programmably adjustable non-zero current amplitudes during each of the first and second color fields to correspond to the selected mode.

19. The method of claim 18, wherein one of the plurality of operating modes increases brightness and power efficiency of the first and second light sources by utilizing a reduced color gamut, or grey scale color range.

20-21. (canceled)

22. An apparatus comprising:
at least three light emitting diodes, each emitting light at different wavelengths from the other, wherein the light is directed to a spatial light modulator that forms an image using time-separated color fields;
a driver that provides an adjustable, constant current source to each of the light emitting diodes, the driver including one or more enable inputs to selectably enable and disable each of the light emitting diodes in synchronization with the color fields; and
at least one current controlling device coupled to the driver, wherein the at least one current controlling device simultaneously provides, to the two or more of the light emitting diodes via the driver, programmably adjustable, non-zero current amplitudes during two or more of the color fields.

23. The apparatus of claim 22, wherein the color fields comprise three color fields, and wherein the at least one current controlling device comprises three current controlling devices, each associated with a respective one of the three color fields, the apparatus further comprising a switching device that selectably couples the three current controlling devices to the driver during each of the three color fields.

24. The apparatus of claim 23, further comprising a controller coupled to the current controlling devices to provide one or more digital words for setting each of the programmably adjustable, non-zero current amplitudes during the two or more of the color fields, the controller further coupled to the switching device provide an input that causes the switching device to selectably couple the three current controlling devices to the driver during each of the three color fields.

25. The apparatus of claim 22, wherein the light emitting diodes are commonly coupled at respective anodes of the light emitting diodes.

26. The apparatus of claim 22, further comprising a controller coupled to the current controlling device to provide a digital word for setting each of the programmably adjustable, non-zero current amplitudes during the two or more color fields.

27. The apparatus of claim 26, wherein the controller is coupled to the driver to provide one or more enable signals to the one or more enable inputs in synchronization with the two or more color fields.

28. The apparatus of claim 27, further comprising a logical OR gate having: a) an output coupled to the one or more enable inputs of the driver; and b) two or more inputs coupled to the enable signals; wherein the logical OR gate enables all of the light emitting diodes via the driver in response to any one of the enable signals.
